(19) United States
(12) Patent Application Publication
(10) Pub. No.: US 2008/0042316 A1
(43) Pub. Date: Feb. 21, 2008

(54) Method for Producing Concrete Stones with a Modular Molding Structure

(76) Inventor: Peter Geiger, Neumarkt/Opf (DE)

Correspondence Address: WILLIAM COLLARD;COLLARD & ROE, P.C., 1077 NORTHERN BOULEVARD, ROSLYN, NY, 11576, US

(21) Appl. No.: 10/586,511

(22) PCT Filed: Jan. 18, 2005
(86) PCT No.: PCT/DE05/00061

§ 371 Date: May 17, 2007

(30) Foreign Application Priority Data
Jan. 20, 2004 (EP) 04001065.4

(51) Int. Cl. B28B 7/26; B30B 15/02

(52) U.S. Cl. 264/219; 249/119

(57) ABSTRACT

The invention relates to a method for producing concrete stones during which a number of individually selectable separate molds can be placed on a base frame, and the base frame X is fitted with a number of selected separate molds A, B, C and D. The separate molds A, B, C and D are detachably joined to the base frame X in order to hold the separate molds A, B, C and D in place. The separate molds A, B, C and D are filled with liquid concrete material. Hardened concrete stones are removed from the separate molds A, B, C and D, after which the separate molds A, B, C and D are detached from the base frame X.

The invention relates to a method for producing concrete blocks with a modular mold structure.

A rigid mold for producing sets of concrete blocks is known from EP 0 274 344 A1 as prior art. With such a mold, only individual concrete blocks can be produced, with sizes predetermined by the rigid mold. Production of concrete blocks of other sizes is only possible by producing a new rigid mold in its entirety.

The invention is based on the object of providing a method for producing concrete blocks which makes it possible to produce a large number of different concrete blocks at low cost. Furthermore, mold elements for carrying out such a method are to be provided.

The object is achieved for the method by the features of patent claim 1. Advantageous variants of the method are described in the subclaims 2-7. For the mold elements, the object is achieved by the features of patent claims 8, 9 and 10.

With the method according to the invention, concrete blocks of different sizes can be produced, according to the wishes of the customer or the manufacturer. This is made possible by the mold that is required for producing the concrete blocks being of a modular structure and having on the one hand a base frame and on the other hand individually selectable separate molds which can be attached to said base frame.

According to the wishes of the customer and manufacturer, a wide variety of separate molds can be selected and attached to a predetermined base frame for each and every working step.

Consequently, by accommodating different separate molds, the method according to the invention makes variable production of concrete blocks of different sizes possible. By contrast with conventional rigid molds of metal (for example of metal, wood, Pegoplan, plastic, clay or ceramic) with filled, predetermined inner shapes, the method according to the invention makes it possible for a predetermined base frame to be fitted with different inner frames, so that different concrete blocks can be produced in production sequences directly following one after the other.

This method can be used particularly advantageously when working with liquid concrete, flow concrete and self-compacting concrete, in particular by the wet-casting method. In this case, the complete mold that is provided, that is to say the respective base frame with separate molds accommodated in it, is filled. After that, the concrete blocks produced are removed from the separate molds and, finally, the separate molds are separated again from the base frame. Altogether, the method according to the invention consequently makes particularly flexible production possible for concrete blocks produced with liquid concrete.

According to an advantageous variant of the method, a base frame is provided and may be configured for example as a wooden or metal supporting frame. In a way similar to in the case of a modular construction kit, different fixed or elastic separate molds can be fitted into this base frame until the base frame is completely filled. Instead of complete filling, dummies may also be introduced.

After filling the base frame with separate molds, the base frame and the separate molds are detachably connected to one another by means of corresponding connecting elements (for example pins and openings, tongues and grooves, rebates, fits, clamping, screws, etc.), in order to prevent undesired movement of the separate molds when flow concrete is introduced, and possibly also during transport and stacking.

The flow concrete introduced fills the cavities of the individual molds; after curing, concrete blocks with the sizes of the separate molds can be removed from the separate molds.

In a next working step, the base frame can be fitted with other separate molds; concrete blocks of other sizes can be produced.

If desired, different, ever-changing, separate molds may be attached to the base frame and consequently concrete blocks of different sizes, shapes and figures can be produced according to the wishes of the customer or manufacturer, without a large number of rigid mold inserts being required.

According to a particularly advantageous variant of the method, the respective individually selectable separate molds are kept in a storage area (for example a high-bay warehouse). They can be removed and taken to a prepared base frame for fitting by means of customary removal robots that are known per se.

Once production has been performed, the base frame and the separate molds are detached again from one another and separate molds that are no longer required are returned to the storage area. The base frame can be used again and again and be fitted with new separate molds.

Consequently, the method according to the invention makes fully automatic control of the production process possible. In a first method step, the separate molds desired by the customer or manufacturer are selected at a computer user station (for example a personal computer). After that, a corresponding order is issued and the separate molds are removed from the storage area and taken to a prepared base frame, introduced into it (for example inserted) and detachably connected to it.

The base frames and separate molds according to the invention are, in particular, of a modular structure and form a modular mold system which can be plugged together and locked and unlocked, and which can be detachably put together in a way known per se (for example by pin connections).

The invention is explained in more detail on the basis of exemplary embodiments in the figures of the drawing, in which:

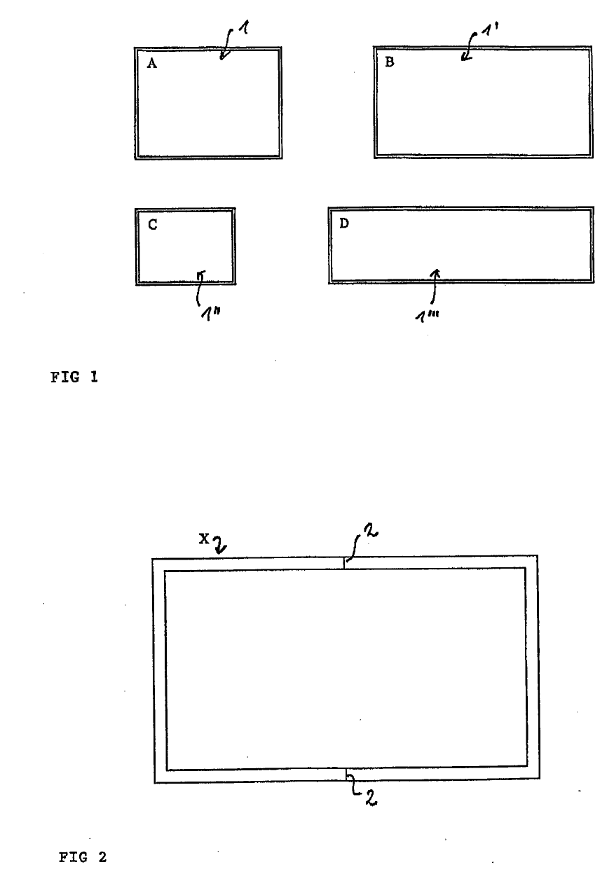

FIG. 1 shows a selection by way of example of four separate molds A, B, C and D,

FIG. 2 shows a representation by way of example of a base frame X,

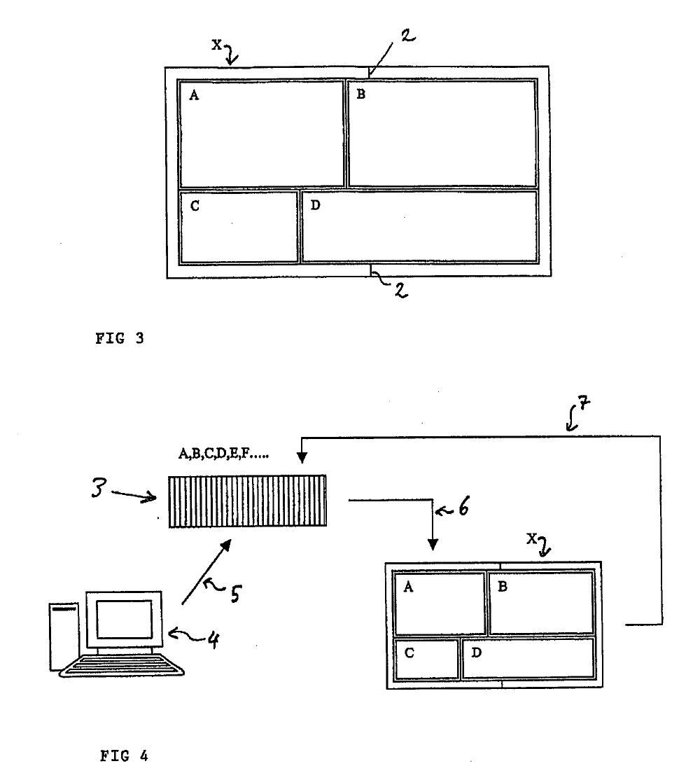

FIG. 3 shows a complete mold formed in a modular manner and

FIG. 4 shows a schematic representation of the method for producing concrete blocks.

FIG. 1 shows four different separate molds A, B, C and D (in particular fillable frame elements with bases, the frame elements having, for example, a rectangular cross section). Such separate molds A, B, C and D may be kept in a storage area 3, in particular in an automated rack store. The separate molds A, B, C and D may in this case comprise frame elements comprising, for example, plastic or wooden frames. Altogether, the separate molds A, B, C and D serve for filling with concrete material, in particular liquid concrete material, to create concrete blocks corresponding to the size of the inner spaces 1 of the separate molds A, B, C and D.

FIG. 2 shows a base frame X to which separate molds A, B, C and D according to FIG. 1 can be attached. For this purpose, the base frame X may have separating locations 2 for opening. The separate molds A, B, C and D may have pins which can be pushed into openings of neighboring separate molds A, B, C and D or of the base frame X, as in a construction kit.

FIG. 3 shows such separate molds A, B, C and D according to FIG. 1 introduced into a base frame X according to FIG. 2. A complete mold of a modular form is obtained, it being possible for the base frame X to be fitted in a next production sequence with new separate molds E, F, G, H, I etc. (not depicted), which can be selected from an overall stock of separate molds.

FIG. 4 shows a computer user station 4 (for example a personal computer) for the selection 5 of specific separate molds A, B, C, D, E, F etc. from a storage area 3 for the fitting 6 into a base frame X. Once production has been performed, the separate molds are returned again, possibly after cleaning, to the storage area 3 (step 7).

### DESIGNATIONS

1 inner space
2 separating location
3 storage area
4 computer user station
5 selection
6 fitting
7 return
A, B, C, D, E, F separate molds
X base frame

1. A method for producing concrete blocks, it being possible for a number of individually selectable separate molds to be attached to a base frame, comprising the following method steps:
fitting of the base frame with a number of selected separate molds,
filling the separate molds with liquid concrete material,
removing the cured concrete blocks from the separate molds,
separating the separate molds from the base mold.

2. The method as claimed in claim 1, the base frame being formed as an outer frame.

3. The method as claimed in claim 2, a number of separate molds being detachably attached in the interior of the outer frame.

4. The method as claimed in claim 1, the separate molds being detachably connected to one another.

5. The method as claimed in claim 1, a range of different separate molds being kept in a storage area.

6. The method as claimed in claim 5, individually selectable separate molds being taken by means of an automatic removal device from the storage area to the base frame for fitting.

7. The method as claimed in claim 1, the separate molds being separated from the base frame and returned to the storage area after use.

8. A base frame for producing concrete blocks, in particular for producing concrete blocks by a method as claimed in claim 1, it being possible for the base frame to be detachably connected to separate molds for filling with liquid concrete material inner molds.

9. A separate mold for attaching to a base frame, as claimed in claim 8, the separate mold having connecting elements for the detachable connection to corresponding connecting elements of the base frame.

10. A modular mold system for producing concrete blocks, with a base frame, to which one or more individually selectable separate molds can be detachably attached for filling with liquid concrete material.
